(19) United States
(12) Patent Application Publication
(10) Pub. No.: US 2025/0258355 A1
(43) Pub. Date: Aug. 14, 2025

(54) LENS BARREL, LENS APPARATUS, AND IMAGE PICKUP APPARATUS

(71) Applicant: CANON KABUSHIKI KAISHA, Tokyo (JP)

(72) Inventor: TAKEHIKO SATO, Tochigi (JP)

(21) Appl. No.: 19/021,995

(22) Filed: Jan. 15, 2025

(30) Foreign Application Priority Data
Feb. 14, 2024 (JP) 2024-020480

(51) Int. Cl. G02B 7/10

(52) U.S. Cl. CPC G02B 7/10

(57) ABSTRACT

A lens barrel having a first optical system and a second optical system which are arranged in parallel with respect to an image pickup element and guide light to the image pickup element, includes: an integrated holding member integrally formed to hold an 11 lens unit included in the first optical system and a 21 lens unit included in the second optical system and corresponding to the 11 lens unit; a first holding member which holds a 12 lens unit included in the first optical system; a second holding member that holds a 22 lens unit included in the second optical system and corresponding to the 12 lens unit; and a base lens barrel to which the integrated holding member, the first holding member and the second holding member are fixed.

### BACKGROUND

### Technical Field

The disclosure relates to a lens barrel, a lens apparatus, and an image pickup apparatus.

### Description of the Related Art

There is known a technique of performing stereoscopic imaging by an image pickup apparatus in which two optical systems are arranged in a horizontal direction. Japanese Patent Application Laid-Open No. H08-242468 discloses a technique for performing focusing control of a pair of left and right lens barrels.

Japanese Patent Application Laid-Open No. H08-242468 discloses a technique in which in an image pickup apparatus using a first lens barrel for a right eye and a second lens barrel for a left eye, focus information of the first lens barrel is calculated, and focus adjustment of the second lens barrel is performed based on the calculated focus information.

When the viewer views the image formed on the image sensor by the first optical system of the first lens barrel and the image formed on the image sensor by the second optical system of the second lens barrel with the right eye and the left eye, respectively, the respective images are fused and can be recognized as a stereoscopic image. However, if a difference in relative position between each lens unit and the image pickup element becomes large due to a manufacturing error caused by the dimensions of the components constituting each lens barrel or an assembly of those components, the viewer easily feels a difference in image quality between the right eye image and the left eye image. When the difference in image quality is large, it becomes difficult for the viewer to fuse the images of the left and right eyes, and fatigue the viewer feels at the time of viewing may increase.

In addition, the thickness of the lens-holding barrel at the closest point between the first and second optical systems is a constraint for increasing the diameter of the lens to improve optical performance, given the width (base length) of the left and right eyes.

### SUMMARY

A lens barrel according to the disclosure is a lens barrel having a first optical system and a second optical system which are arranged in parallel to an image pickup element and guide light to the image pickup element, wherein an optical system includes an integrated holding member integrally formed to hold an eleventh lens unit included in the first optical system and a twenty-first lens unit corresponding to the eleventh lens unit included in the second optical system, a first holding member holding a twelfth lens unit included in the first optical system, a second holding member holding a twenty-second lens unit corresponding to the twelfth lens unit included in the second optical system, and a base barrel to which the integrated holding member, the first holding member, and the second holding member are fixed.

Further features of the disclosure will become apparent from the following description of exemplary embodiments with reference to the attached drawings.

### BRIEF DESCRIPTION OF THE DRAWINGS

FIG. 1 is a cross-sectional view of an interchangeable lens for a single-lens reflex camera including a lens barrel according to an embodiment and a camera body.

FIG. 2 is a perspective view of the first unit lens barrel 111 according to the embodiment.

FIG. 3 is a horizontal cross-sectional view of the first unit lens barrel 111 according to the embodiment.

### DESCRIPTION OF THE EMBODIMENTS

Hereinafter, a lens barrel 100, a lens apparatus, and an image pickup apparatus according to embodiments of the disclosure will be described in detail with reference to the accompanying drawings.

The disclosure relates to a lens barrel, a lens apparatus, and an image pickup apparatus which are capable of performing stereoscopic shooting by moving at least a part of a first optical system and a second optical system, which are disposed in parallel to an image pickup element and guide light to the image pickup element, in an optical axis direction to perform zoom or focus adjustment.

### Embodiments

A lens barrel 100 according to an embodiment of the disclosure will be described.

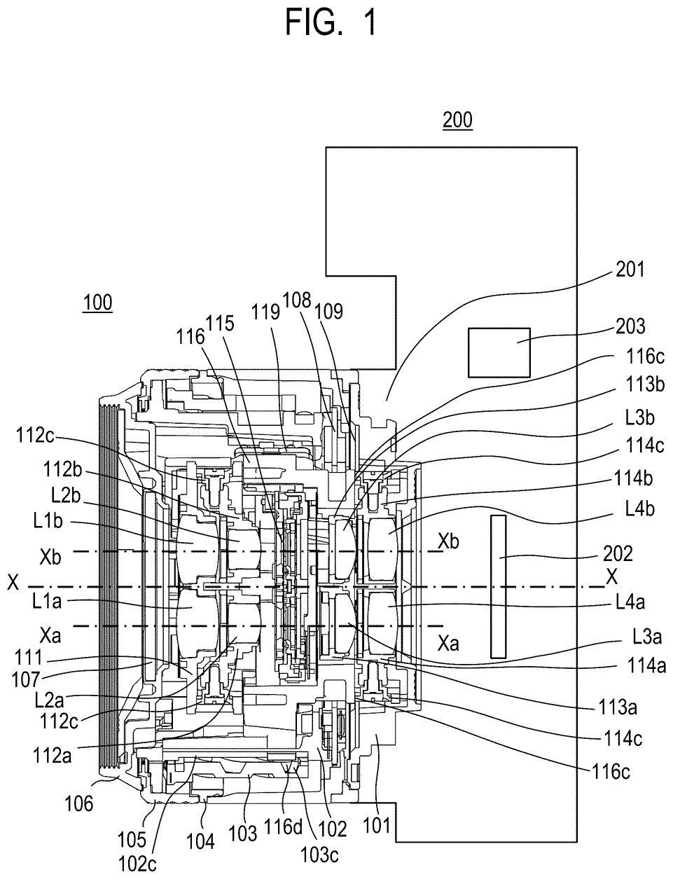

FIG. 1 is a cross-sectional view of an image pickup apparatus including an interchangeable lens (lens apparatus) for a single-lens reflex camera including the lens barrel 100 according to an embodiment of the disclosure and an image pickup element 202 that picks up an image formed by the lens.

A line Xa-Xa in the drawing represents an optical axis of a first optical system that forms an image for the left eye. A line Xb-Xb in the drawing represents an optical axis of a second optical system that forms an image for the right eye. A line indicated by X-X in the drawing represents an optical axis of the entire lens barrel 100 which is a center between Xa-Xa and Xb-Xb. In the following description, an element related to the first optical system is denoted by a reference numeral a, and an element related to the second optical system is denoted by a reference numeral b.

A mount 101 provided in the lens barrel 100 is a component having a bayonet portion to be attached to a camera mount 201 provided in the camera body 200. A guide barrel 102 is integrally fixed to the mount 101 together with an outer cylinder 104. A cam barrel 103 is rotatably held around the optical axis on the outer circumference of the guide barrel 102. The cam barrel 103 is connected to a stepping motor unit (not shown) held at an image-side end portion of the guide barrel 102 by gears. The cam barrel 103 is configured to rotate when the stepping motor unit rotates according to control information from a control board 108.

A contact block 109 is electrically connected to the control board 108, and the control board 108 communicates with the camera body 200 via the contact block 109 and receives power supply from the camera body 200. When a shutter button provided in the camera body 200 is operated, the image pickup element 202 is controlled by a camera control circuit 203 so that an image formed on the image pickup element 202 by the first optical system and the second optical system is captured. Since the first optical system and the second optical system are arranged in parallel with respect to the image pickup element 202, two image circles are formed in parallel in the image pickup element 202. A charge coupled device (CCD), CMOS (Complementary Metal Oxide Semiconductor), or the like is used as the image pickup element 202.

In addition, the first optical system and the second optical system are optically constituted by the same lens unit and are disposed at a constant interval (base length) therebetween in the left-right direction. A cover glass 107 of a forefront surface held by a filter frame 106 fixed to the guide barrel 102 with screws is intended to protect the inside of the lens barrel and does not have an optical function. A first optical system for the left eye and a second optical system for the right eye are disposed on the image side of the cover glass 107.

The first optical system includes, in order from the object side to the image side, a first unit left lens (11 lens unit) L1a, a second unit left lens (12 lens unit) L2a, a third unit left lens (12 lens unit) L3a, and a fourth unit left lens (12 lens unit) L4a. The second optical system includes, in order from the object side to the image side, a first unit right lens (21 lens unit) L1b, a second unit right lens (22 lens unit) L2b, a third unit right lens (22 lens unit) L3b, and a fourth unit right lens (22 lens unit) L4b.

Optically, the first unit left lens L1a corresponds to the first unit right lens L1b, the second unit left lens L2a corresponds to the second unit right lens L2b, the third unit left lens L3a corresponds to the third unit right lens L3b, and the fourth unit left lens L4a corresponds to the fourth unit right lens L4b.

Both the first unit left lens L1a of the first optical system and the first unit right lens L1b of the second optical system are lens units disposed closest to the object side and are held by a first unit lens barrel (integrated holding member) 111 as a lens holding frame formed of one integrated member. The first unit lens barrel 111 is fixed to a main base (base lens barrel) 116 by screws in the optical axis direction.

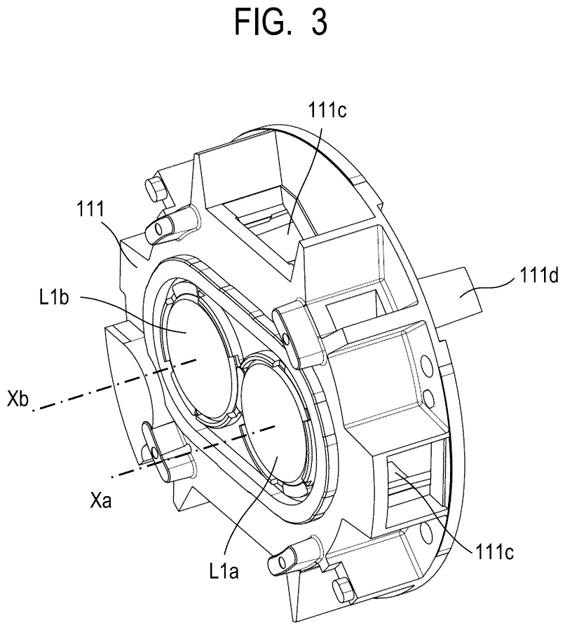

The second unit left lens (12 lens unit) L2a is held by a second unit left lens barrel (a first holding member) 112a. The second unit right lens (22 lens unit) L2b is held by a second unit right lens barrel (second holding member) 112b. Three second unit eccentric rollers 112c are fixed to each of the second unit left lens barrel 112a and the second unit right lens barrel 112b by screws at intervals of approximately 120 degrees in a circumferential direction of the lens barrel 100. The second unit eccentric roller 112c has a cylindrical portion which is eccentric with respect to a central axis of the screw fixed to the second unit left lens barrel 112a or the second unit right lens barrel 112b. The cylindrical portion engages with a second unit eccentric roller engaging groove 111c (see FIG. 3) provided in the first unit lens barrel 111. By rotating the second unit eccentric roller 112c around the axis of the screw, an axial position with respect to the second unit eccentric roller engaging groove 111c changes in a plane having a normal line perpendicular to the optical axis.

Therefore, the relative positions of the second unit left lens barrel 112a and the second unit right lens barrel 112b with respect to the first unit lens barrel 111 can be changed. Therefore, the positions of the second unit left lens L2a and the second unit right lens L2b in the optical axis direction, the eccentricity direction, and the inclination direction can be changed with respect to the first unit left lens L1a and the first unit right lens L1b held by the first unit lens barrel 111. As a result, it is possible to perform optical adjustment for correcting the positional deviation in the optical axis direction and the optical axis deviation occurring in the lens unit due to a manufacturing error.

The fourth unit left lens (12 lens unit) L4a is held by a fourth unit left lens barrel (a first holding member) 114a. The fourth unit right lens (22 lens unit) L4b is held by a fourth unit right lens barrel (second holding member) 114b. Three fourth unit eccentric rollers 114c are fixed to each of the fourth unit left lens barrel 114a and the fourth unit right lens barrel 114b by screws at intervals of approximately 120 degrees in the circumferential direction. The fourth unit eccentric roller 114c has a cylindrical portion which is eccentric with respect to a central axis of a screw fixed to the fourth unit left lens barrel 114a or the fourth unit right lens barrel 114b. The cylindrical portion engages with a fourth unit eccentric roller engaging groove 116c provided in the main base 116. By rotating the fourth unit eccentric roller 114c around the axis of the screw, the axial position with respect to the fourth unit eccentric roller engaging groove 116c changes in a plane having a normal line perpendicular to the optical axis.

Therefore, the relative positions of the fourth unit left lens barrel 114a and the fourth unit right lens barrel 114b with respect to the first unit lens barrel 111 fixed to the main base 116 can be changed. Therefore, the positions of the fourth unit left lens L4a and the fourth unit right lens L4b in the optical axis direction, the eccentricity direction, and the inclination direction can be changed with respect to the first unit left lens L1a and the first unit right lens L1b held by the first unit lens barrel 111. As a result, it is possible to perform optical adjustment for correcting a positional deviation in the optical axis direction or an optical axis deviation occurring in the lens unit due to a manufacturing error.

The third unit left lens (12 lens unit) L3a is held by a third unit left lens barrel (first holding member) 113a. The third unit left lens barrel 113a is fixed to the main base 116 by screws. The third unit right lens (22 lens unit) L3b is held by a third unit right lens barrel (second holding member) 113b. The third unit right lens barrel 113b is supported movably in the optical axis direction by two guide bars (not shown) extending in the optical axis direction. The two guide bars are held by the first unit lens barrel 111 and the main base 116.

A stepping motor 119 having a lead screw is fixed to the main base 116 by screws. A rack (not shown) engaged with the lead screw of the stepping motor 119 is held by the third unit right lens barrel 113b. When the stepping motor 119 rotates based on a control signal from the control board 108, the rack is driven, and the third unit right lens barrel 113b moves forward and backward in the optical axis direction with respect to the main base 116.

The electromagnetic aperture stop unit (light amount adjusting unit) 115 is held by the first unit lens barrel 111 and the main base 116. The electromagnetic aperture stop unit 115 has a first opening through which the light beam of the first optical system passes and a second opening through which the light beam of the second optical system passes, and a plurality of diaphragm blades are provided in each of the first opening and the second opening. The plurality of diaphragm blades of the first opening and the second opening are driven by an aperture stop drive motor controlled by the control board 108, and the amount of light reaching the image pickup element 202 is adjusted by changing the area of the opening.

An image is formed on the image pickup element 202 by the first optical system and the second optical system. A manufacturing error such as a dimensional deviation of each component from a design value or an attachment position deviation in assembly may cause a decrease in optical performance in an image obtained on the image pickup element 202. By the optical adjustment of the second unit left lens L2a and the second unit right lens L2b using the second unit eccentric roller 112c and the optical adjustment of the fourth unit left lens L4a and the fourth unit right lens L4b using the fourth unit eccentric roller 114c, it is possible to bring the optical performance close to the design value. When there is a difference in focus between the images of the left and right eyes due to factors such as relative positional deviation of the first optical system and the second optical system and inclination with respect to the image pickup element 202, the third unit right lens L3b can be moved back and forth in the optical axis direction by the stepping motor 119 to adjust them.

The main base 116 is provided with cam followers 116d at intervals of approximately 120 degrees in the circumferential direction. The cam follower 116d engages with a rectilinear groove 102c extending in the optical axis direction provided in the guide barrel 102 and a cam groove 103c provided in the cam barrel 103. When the cam barrel 103 rotates with respect to the guide barrel 102, the cam follower 116d advances and retreats in the optical axis direction. As described above, since the respective lens units of the first optical system and the second optical system are held in the main base 116, the respective lens units of the first optical system and the second optical system can integrally move in the optical axis direction with respect to the image pickup element 202 by advancing and retreating of the cam follower 116d.

When a control signal is sent to a gear unit and the cam ring rotates based on focusing information obtained by processing the image obtained by the image pickup element 202 by the camera control circuit 203, the cam follower 116d moves forward and backward in the optical axis direction to perform focusing operation. Alternatively, when a photographer rotates a focus operation ring 105 around the optical axis, a control signal is sent from the control board 108 to the gear unit in accordance with the rotation amount detected by a focus operation ring rotation sensor (not shown) to rotate the cam barrel 103. With this operation, the cam follower 116d can move similarly forward and backward to perform the focusing operation.

Although a stepping motor 119 having a lead screw is used to drive the third unit right lens barrel 113b and a stepping motor unit coupled to a gear is used to rotate the cam barrel 103, the configuration of the disclosure is not limited thereto. For example, a DC motor or an ultrasonic motor may be used for the driving.

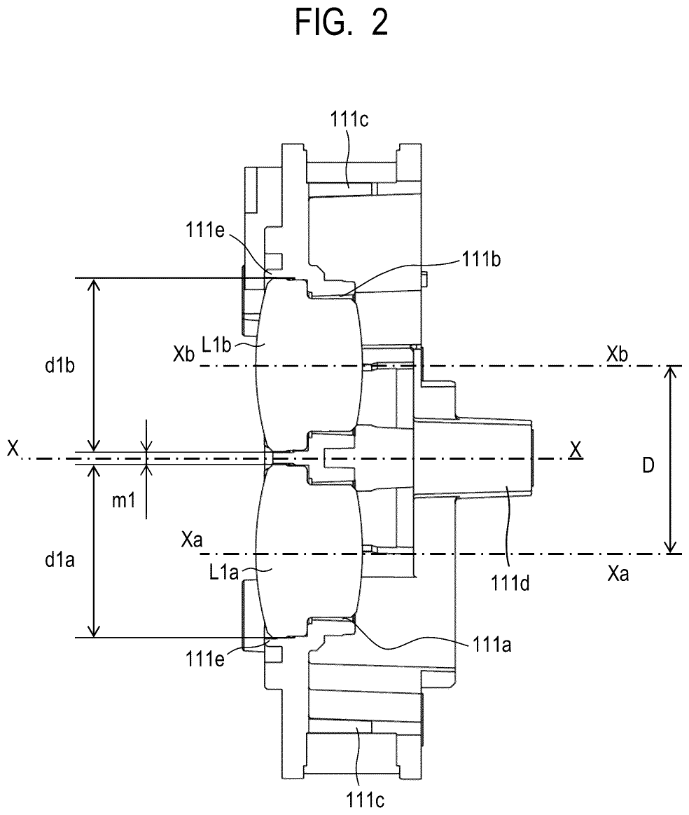

FIG. 2 is a perspective view of the first unit lens barrel 111 of the present embodiment. The first unit lens barrel 111 holds the first unit left lens L1a and the first unit right lens L1b. By holding the first unit left lens L1a and the first unit right lens L1b by one component in this way, it is possible to suppress the positional deviation of the lens with respect to the image pickup element 202 as compared with a case where the respective lenses are held by individual lens barrels. In the case where the lens barrels are held by individual lens barrels, a relative position deviation occurs in fixing the lens barrels to the main base 116 in addition to a component dimension deviation of the lens barrels. However, if the holding is carried out by one lens barrel integrated for the left and right eyes as in the present embodiment, the positional deviation in fixing to the main base 116 is caused by an extent of only one component, and the positional deviation can be relatively reduced as compared with the case of fixing of two components individually. Therefore, it is possible to relatively stabilize the optical performance.

Although the first optical system and the second optical system are held by the main base 116, they are integrally movable in the optical axis direction as described above. If a strong impact is applied to the lens barrel 100 due to a dropping or the like, the first optical system and the second optical system may move forward and backward in the optical axis direction while being supported by the guide barrel 102 and the cam barrel 103 inside the exterior of the lens barrel 100. In such case, the attachment position of the first unit lens barrel 111 with respect to the main base 116 may slightly change due to the first unit lens barrel 111 abutting against the fixed component inside the exterior of the lens barrel 100. Also in this case, if the lenses are held by one lens barrel integrated for the left and right eyes as in the present embodiment, the positional deviation in fixing to the main base 116 is caused in an extent of only one component, and the positional deviation can be relatively reduced as compared with the case of fixing of two components individually. Therefore, it is possible to relatively stabilize the optical performance.

The first unit lens barrel 111 has an aperture stop unit contact portion 111d extending in the optical axis direction. The electromagnetic aperture stop unit 115 is sandwiched between the aperture stop unit contact portion 111d of the first unit lens barrel 111 and the main base 116, and the aperture stop unit contact portion 111d contacts the electromagnetic aperture stop unit 115 to position the electromagnetic aperture stop unit 115 in the optical axis direction. As for the fixing of the electromagnetic aperture stop unit 115 in the same manner as the lens holding, the holding accuracy can be enhanced by using only one component in the case of holding by the lens barrel integrated for the left and right eyes, as compared with the case of using the lens barrels individually provided for the left and right eyes.

FIG. 3 is a horizontal cross-sectional view of the first unit lens barrel 111 of the present embodiment. The left-eye lens opening 111a and the right-eye lens opening 111b are separated from each other by a base length D that is a predetermined distance. Since the first optical system for the left eye and the second optical system for the right eye capture images with parallax by the base length D, the viewer can obtain a stereoscopic effect. In general, in order to improve the image quality of the optical system, it is effective to increase the lens diameter to increase the amount of light. However, in order to hold the lens, a lens barrel holding portion 111e is required on the outer periphery of the lens unit.

When the lens diameter d1a of the first unit left lens L1a and the lens diameter d1b of the first unit right lens L1b are increased under a condition that the base length D is constant, the lens barrel holding portion 111e between the first unit left lens L1a and the first unit right lens L1b becomes a constraint of the upper limit of the lens diameter. In a case where the lenses for the left and right eyes are held by individual lens barrels, thick portions of the lens barrel holding portions 111e for two lens barrels are located in a central portion which is a closest position between the first unit left lens L1a and the first unit right lens L1b.

On the other hand, in the present embodiment, the first unit left lens L1a and the first unit right lens L1b are held by one lens barrel integrated for the left and right eyes. The first unit left lens L1a and the first unit right lens L1b are lenses having the largest diameter among the first optical system and the second optical system, respectively. Therefore, in the portion between the first unit left lens L1a and the first unit right lens L1b, it is possible to reduce the thickness (m1 in FIG. 3) as compared with the case where the lenses are held by individual lens barrels. Therefore, the lens barrel 100 of the present embodiment can improve the optical performance by increasing the lens diameter under the condition that the base length D is constant in the optical design in which the optical axis is not bent.

Although the embodiments have been described with respect to the interchangeable lens, the same effect can be obtained when the lens barrel for recording an image has a two-lens configuration. Further, although the present embodiment has been described with respect to a single focal length lens having a fixed focal length, the disclosure is also applicable to a zoom lens having a variable focal length.

While the embodiments of the disclosure have been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-020480, filed Feb. 14, 2024, which is hereby incorporated by reference herein in its entirety.

What is claimed is:

1. A lens barrel having a first optical system and a second optical system which are arranged in parallel with respect to an image pickup element and guide light to the image pickup element, comprising:
an integrated holding member integrally formed to hold an 11 lens unit included in the first optical system and a 21 lens unit included in the second optical system and corresponding to the 11 lens unit;
a first holding member that holds a 12 lens unit included in the first optical system;
a second holding member that holds a 22 lens unit included in the second optical system and corresponding to the 12 lens unit; and
a base lens barrel to which the integrated holding member, the first holding member, and the second holding member are fixed.

2. The lens barrel according to claim 1, wherein positions of the first lens barrel and the second lens barrel can be adjusted with respect to the base lens barrel.

3. The lens barrel according to claim 1,
wherein the integrated holding member includes a contacting portion that contacts a light amount adjusting unit configured to adjust a light amount of a light beam passing through each of the first optical system and the second optical system, and
wherein the integrated holding member is fixed to the base lens barrel so as to sandwich the light amount adjusting unit between the integrated holding member and the contacting portion in the optical axis direction.

4. The lens barrel according to claim 1, wherein the base lens barrel is movable in the optical axis direction.

5. The lens barrel according to claim 1, further comprising: a cam barrel having a cam groove; and a guide barrel having a rectilinear groove extending in the optical axis direction,
wherein the base lens barrel has a cam follower that engages with the cam groove and the rectilinear groove,
wherein the cam barrel and the guide barrel rotate relative to each other around the optical axis to cause the base lens barrel move in the optical axis direction.

6. The lens barrel according to claim 1, wherein a position of the first holding member can be adjusted with respect to the second holding member.

7. The lens barrel according to claim 6, wherein the first holding member is moved with respect to the base lens barrel by a motor fixed to the base lens barrel.

8. A lens apparatus, comprising a lens barrel having a first optical system and a second optical system which are arranged in parallel with respect to an image pickup element and guide light to the image pickup element, the lens barrel comprising:
an integrated holding member integrally formed to hold an 11 lens unit included in the first optical system and a 21 lens unit included in the second optical system and corresponding to the 11 lens unit;
a first holding member that holds a 12 lens unit included in the first optical system;
a second holding member that holds a 22 lens unit included in the second optical system and corresponding to the 12 lens unit; and
a base lens barrel to which the integrated holding member, the first holding member, and the second holding member are fixed.

9. The lens apparatus according to claim 8, wherein the 11 lens unit is a lens unit including a lens having a largest diameter in the first optical system, the 21 lens unit is a lens unit including a lens having a largest diameter in the second optical system.

10. The lens apparatus according to claim 8, wherein the 11 lens unit is a lens unit disposed closest to the object side in the first optical system, the 21 lens unit is a lens unit disposed closest to the object side in the second optical system.

11. An Image pickup apparatus, comprising: a lens apparatus having a lens barrel; and an image pickup element for picking up an image formed by the lens apparatus,
wherein the lens barrel having a first optical system and a second optical system which are arranged in parallel with respect to an image pickup element and guide light to the image pickup element, the lens barrel comprising:
an integrated holding member integrally formed to hold an 11 lens unit included in the first optical system and a 21 lens unit included in the second optical system and corresponding to the 11 lens unit;
a first holding member that holds a 12 lens unit included in the first optical system;
a second holding member that holds a 22 lens unit included in the second optical system and corresponding to the 12 lens unit; and
a base lens barrel to which the integrated holding member, the first holding member, and the second holding member are fixed.
